(19) United States
(12) Patent Application Publication
(10) Pub. No.: US 2016/0093007 A1
(43) Pub. Date: Mar. 31, 2016

(54) Transactional Real Estate System

(71) Applicant: SQFTx, Inc., Boulder, CO (US)

(72) Inventors: Daniel Richardson, Boulder, CO (US); Andrew Brandt, Boulder, CO (US); Jan Delany, Boulder, CO (US); Kevin Cawley, Boulder, CO (US); Mark Kreloff, Boulder, CO (US); James Simpson, Boulder, CO (US)

(21) Appl. No.: 14/865,942

(22) Filed: Sep. 25, 2015

Related U.S. Application Data
(60) Provisional application No. 62/055,525, filed on Sep. 25, 2014.

(51) Int. Cl. G06Q 50/16; G06Q 50/18; G06Q 30/06

(52) U.S. Cl. CPC G06Q 50/16; G06Q 30/0611; G06Q 50/188

(57) ABSTRACT

The disclosure a computer implemented method for transaction of a real estate property. The method may include receiving information from a first user device. The information may include data that corresponds to an offer to sell a real estate property. A set of terms may be extracted from the received data. The set of terms may include an offer price, a payment method for the offer price, and a series of milestones each comprising an associated closing time. A packaged offer may be created based on the extracted set of terms. The packaged offer may include attributes of the product stored on a memory device accessible to the processing device and the extracted set of terms. The packaged offer may be transmitted to a second user device.

### RELATED APPLICATION

This application claims benefit of U.S. Provisional Application No. 62/055,525 filed on Sep. 25, 2014. The disclosures of the above applications are incorporated herein by reference in their entirety.

### INTRODUCTION

Engaging in online economic activity via the Internet is becoming increasingly common. Electronic commerce (e-commerce) web sites and e-commerce applications are rapidly proliferating. Internet users can, among other things, bank, invest, buy and sell goods and services, and engage in a wide variety of forms of entertainment online One area of commerce that has not yet fully taken advantage of the potential of the Internet is the real estate market, and, in particular, the residential real estate market. This is true for a couple of reasons. First, real estate, especially residential real estate, is being bought and sold according to a decade's old paradigm. That is, the key players in the industry, realtors, mortgage brokers, and title companies, are fairly conservative, somewhat technically unsophisticated, and generally reluctant to embrace change. This results in a process which, for many home sellers and buyers, is shrouded in mystery, appearing arcane and convoluted, not to mention inefficient, inconvenient and expensive.

Second, because of the high level of complexity and the individualized nature of each transaction, remote online facilitation of real estate transactions is a challenging endeavor. That is, in order to facilitate a real estate transaction from beginning to end, the conservative players in the industry must be made to work in a coordinated way and, in some cases, against their own perceived interests, to make the home selling and buying process understandable and user friendly. Furthermore, many of the players in the industry treat each transaction as entirely individual and, therefore, completely unsuitable for automation via an e-commerce solution. To date, this has not been accomplished.

Rather, for example, when someone wants to buy a home under the current paradigm, not only must they spend inordinate amounts of time attending open houses and meeting with their real estate agent, they must also meet and communicate with mortgage brokers, lending institutions, title companies, and escrow officers. This does not even take into account the primary element of the transaction: the negotiation of the terms of the sale itself (particularly any special, non-monitory requirements like pre-closing actions by either party). If the process is being engaged in from a geographically remote location, these inconveniences are only exacerbated. In short, despite the rapid advancement of technology in many areas of commerce, buying or selling a home today remains a very frustrating, inefficient, and time consuming process.

### BRIEF DESCRIPTION OF THE DRAWINGS

Non-limiting and non-exhaustive examples are described with reference to the following figures. As a note, the same number represents the same element or same type of element in all drawings.

FIG. 1 illustrates an exemplary environment in which methods and systems for transaction of real estate described herein may be implemented.

FIG. 2 illustrates an exemplary flow diagram for transaction of real estate as described herein.

FIG. 3A illustrates an exemplary flow diagram of a buyer associated with transaction of a real estate as described herein.

FIG. 3B illustrates another exemplary flow diagram of a buyer associated with transaction of a real estate as described herein.

FIG. 3C illustrates yet another exemplary flow diagram of a buyer associated with transaction of a real estate as described herein.

FIG. 4 illustrates an exemplary flow diagram of an account creation associated with transaction of a real estate as described herein.

FIG. 5 illustrates exemplary flow diagram of a listing creations associated with transaction of a real estate as described herein.

FIG. 6 illustrates one example of a state diagram associated with transaction of real estate as described herein.

FIG. 7 illustrates one example of a suitable operating environment in which one or more of the present examples may be implemented.

### DETAIL DESCRIPTION

The disclosure provides a transactional real estate system (TRES) to facilitate buying and selling of a real-estate property. The TRES may include a database connected to a web application and a user application. The database may store information, such as seller information, property information, status information, buyer information, contract information etc. received from sellers and buyers. The web application may manage the listing of the property on a web page and update a status of the listing based on change in the status of the transaction. The TRES may be connected to one or more third party service providers. For example, the TRES may be connected to a financial service provider, a verification service provider, etc. Buyers and sellers may be directed to these third party service providers during the course of the transaction.

A seller of a real-estate (or a homeowner) may initiate a transaction by accessing a user application associated with the TRES on a user device. The user application may provide a user interface for the seller to create a seller profile. For example, the user application may prompt the seller to provide user information such as his/her name, address, etc. A seller profile may be created using the entered user information. In an alternative embodiment, the seller may upload details of his driving license (photograph or number) or some other identification document like a passport and the TRES system may extract user information from the uploaded document.

Once the seller profile is created, the seller may be prompted to provide property identification information. The user application may provide a user interface, such as a user fillable form, for the seller to enter the property identification information. The property identification information may include, for example, an address of the property, official records of ownership of the property, description of the property (for example total area, built area, number of floors, number of rooms, etc.) The property identification information received from the seller may be sent to the TRES by the user application. Upon receipt of the property identification information, the TRES may post the property on a listing on a web page, a mobile application, or a real estate listing service. At first, the listing may be posted as with a ‘coming soon’ (also referred to as ‘drafted’) status. In the ‘coming soon’ state, the property may not be open for any transaction, but some of the available information on the property may still be viewable by potential buyers. For example, a buyer cannot schedule a showing for the ‘coming soon’ property.

The TRES may verify the received user identification information and the property identification information provided by the seller. For example, the TRES may first verify the user identification information. Once, the user identification information is verified, the TRES may generate a seller's listing agreement. The generated seller's listing agreement may be sent to the user device for assent from the seller. Upon receiving the assent from the seller, the state of the property listing may be updated from ‘coming soon’ (also referred to as ‘drafted’) to ‘unverified’. A buyer may be allowed to request a showing for a property with the ‘unverified’ state. However, a notification is sent to the buyer initiating interest for ‘unverified’ state property. In one example, the ‘unverified’ state label may not be visible to a buyer browsing for the properties.

The TRES may further verify the property identification information provided by the seller. The TRES may verify the property identification information using the third party services. Upon verification of the property identification information, the TRES may change the status of the property listing from the ‘unverified’ to ‘new’ or ‘for sale’. Upon change in the status to ‘new’ or ‘for sale’, a buyer may be free to request showing of the property. Moreover, the TRES may prompt, upon verification of the property identification information, the seller to provide additional information. For example, the TRES may prompt the seller to provide photographs, an asking price, etc. The TRES may guide the seller with the additional information. For example, the TRES may guide the seller about determining asking price.

The buyer interested in the property may access the listing on the user application. For example, a buyer may download the user application and select on a map, an area where he may be looking for a property. Upon selection of the area of interest, the application may provide a listing of property ‘for sale’ in that area. The list may contain filtered property identification information. For example, the filtered information may include an asking price, an address, general build description, number of bedrooms and bathrooms, etc., for each of the properties on the list. Upon selection of a property from the list, the application may provide detailed information for the selected property.

The buyer may select a property listing from the list. Upon selection of a property listing, the TRES may provide additional information about the selected property. For example, the TRES may provide property details, property location, property characteristics, photographs, etc. If the buyer is interested in the selected property, the user application may prompt the buyer to create a buyer profile, if the buyer is new to the system. For example, the TRES system may prompt the buyer to provide buyer identification intimation such as a name, an address, a copy of their driver's license, etc. The TRES may create a buyers profile with the received buyer's identification information. The TRES system may verify the buyer's identity information and generate a buyer's listing agreement. The buyer's listing agreement may be sent to the user application for assent. The buyer may provide assent to the buyer's listing agreement by digitally signing the agreement.

Upon receiving the assent for the buyer's agreement, the TRES may provide a ‘request showing’ option for the selected property. For example, a ‘request showing’ button may be displayed on the user application. Upon selection of the ‘request showing’ option the user application may provide a scheduling interface for scheduling a time for viewing the property. For example, the user application may provide a calendar interface for the buyer to select a date and a time to view the property. The TRES, after the buyer has selected the showing schedule, may bundle the scheduling information with the buyer's information and transmit to the seller. For example, the TRES may provide a notification to the seller of a possible showing for his listed property. The seller may access the bundled information and set a mutually acceptable showing time with the buyer.

Once the buyer has viewed the property, the TRES may prompt the buyer to make an offer for the property. The user application may guide the buyer in preparing an offer for the property. For example, the user application may prompt the buyer to provide an offer price, select a purchase type, set earnest money amount, chose a closing speed of the transaction. The user application may provide an option to include a note as well. The note may be a personalized message for the seller. For example, the buyer may include a message that may not have been included in the bundled information. In addition, the note may include explanation of the offer price, other expectable purchase types, etc.

In one example embodiment, the TRES may allow the buyer to make an offer without requesting a showing. For example, when displaying the listing of the selected property, the user application, may provide an option to make an express offer. The TRES may create a packaged offer based on the buyers input. The packaged offer may include user provided terms as well as standard terms determined by the TRES. The TRES may send the packaged offer to the seller. The packaged offer may be sent in a digital format to the seller.

Upon receiving the packaged offer, the user application may prompt the user to respond to the buyer's offer. For example, the user application may send a notification to the seller of the pending offer for his/her property. The user application may provide a list of the pending offers on the seller's device. For each pending offers, the application may provide the seller an option to reject the offer, an option to accept the offer, an option to ignore the offer, and an option to prepare a counter offer. The seller may select one of the options for the buyer's offer. The TRES may determine a next step in negotiation based on the seller's selection.

For example, if the seller selects the option to ignore the buyer's offer, the offer may expire after a predetermined number of days, and the user application may not allow the seller to accept it after it has expired. If the seller selects the option to reject the buyer's offer, the TRES may notify the buyer of the seller's rejection. When the seller has selected the reject option, the application may provide an option to include a note. In the note, the seller may explain his reason for rejecting the offer and may provide an indication of his/her expectations. The buyer, upon receiving the notification of seller's rejection and the note, may be prompted to consider making a second offer.

If the seller selects the option to make a counter offer in response to the buyer's offer, the application may guide the seller through setting terms and conditions of the counter offer. For example, the application may provide an interface where the seller may either change the buyer's offer or may create an entire new counter offer. The application then may transmit the seller's counter offer to the buyer and prompt the buyer to respond to the sellers counter offer. The buyer may decline the counter offer, may counter the counter offer, or accept the counter offer. When the buyer declines the seller's counter offer, the negotiations may be ended. If the buyer counters the counter offer, the application may again guide the buyer to consider preparing the counter to the counter offer, and transmit it to the seller. The application may allow the buyer and the seller to exchange any number of offers and counter offers before either abandoning the negotiations or reaching an agreement.

If the seller accepts the buyer's offer or buyer accepts the seller's counter offer, a binding contract for the sale of the property may be created. The application may prompt the seller to sign the contract for the sale. After seller's signature, the application may transmit the contract to the buyer for his/her signature as well as the signature of his/her real estate broker, if applicable. Once the application receives both the buyer's and seller's signatures (and buyer's broker, if applicable) on the contract, the TRES may change the status of the property from ‘for sale’ state to an ‘under contract’ state.

Once the property is in ‘under contract’ state, the TRES may send a notification to the buyer to provide the earnest money and later schedule a professional inspection of the property. The TRES may provide a third party inspection service for the inspection. The third party then may provide the inspection report to the TRES system. The TRES may send the inspection report to the buyer and, optionally, the seller. The buyer via the application may accept, counter, or decline the inspection report. If the buyer declines the inspection report, the TRES may end the negotiation. If the buyer accepts the negotiation report, the TRES may create an addendum for the inspection report, and add to the contract. The TRES then may send the contract with added addendum to both the buyer and the seller for their signature.

If the buyer is concerned about anything in the results of the inspection, the user application may guide the buyer to set new terms and create a counter offer based on the inspection report. The new counter offer may include a discount for any needed repairs or improvements. The TRES may send the new counter offer to the seller. The TRES may allow the buyer and seller to exchange any number of counter offers based on the inspection report to a point of either abandoning negotiations or coming to terms of the addendum to the contract. When both parties agree to the terms, the TRES may create the addendum based on the agreed terms. The TRES then may send the contract with added addendum to both the buyer and the seller for their signature, as well as their respective real estate brokers, as applicable. The application may prompt the buyer and the seller to sign the final contract with a predetermined time. If the buyer and the seller do not sign the contract with the predetermined time, the TRES may end the negotiations.

After both the buyer and the seller, as well as their respective real estate brokers, as applicable, sign a final contract, the TRES may change the status of the property from ‘pending contract’ state to ‘under contract’ state. In addition, the TRES may notify the buyer of responsibilities to be ready to close. For example, the TRES may notify the buyer to provide a proof of funds and that the funds must be in an escrow for the transaction to continue to closing. Once the transaction of the property is closed, the property may be removed from the listing on the web page or alternatively labeled as ‘sold” property.

In one embodiment, the TRES may create a state machine for transaction of the real estate property. For example, the TRES may identify a list of milestones in the transaction of a real estate property. These milestones could include, verification of user, listing on the web page, status of negotiations, etc. The TRES may designate each of these identified milestones as a state. The TRES may identify one or more valid transitions for each of the potential states. These state transitions may be identified as buyer's actions, seller's action, or third party actions. The state machine may continuously monitor these defined actions and update the state of the transaction. These updated states may be reflected on the listing of the property on the web page.

In one embodiment, the TRES may provide a time limit for each stage of negotiations. For example, the TRES may set a time limit scheduling the request showing for the buyer after showing interest in the property. The TRES may set a time limit on an initial agreement on offer price and payment method. In addition, the TRES may set a time limit on scheduling the inspection to the property and reaching an agreement on the inspection report. Furthermore, the TRES may set a time limit on post-negotiation activities. For example, the TRES may set a time limit for the buyer to provide the earnest money and provide proof for the funds. If the parties beach any of the predetermined time limits, the TRES may end the negotiations, unless both parties agree on an extension of the set time limits. The application may notify both the parties about the time limit at each stage of the negotiation.

In one embodiment, the TRES may further provide a user specific view for the buyer and seller to manage their transaction related activities. For example, the application may provide a seller with list views of the listed property, a list of buyers requesting showing, a rating for each of the buyers requesting showing, a current state of his/her listing, etc. Similarly, for the buyer the application may provide a list of properties viewed by the buyer, a list of properties for which he has requested showing, ratings for the sellers for these properties, etc. In addition, TRES may provide incentives to both the buyer and the seller. For example, the TRES may provide incentive for the seller in terms of reduced brokerage fees. Similarly, for the buyer, in addition to the reduced brokerage fee, the TRES may provide a rebate and/or allow them access to low interest housing loans or gift coupons for remodeling. For example, sellers may be able to select a co-op commission they are willing to pay to a buyer's broker by manipulating a slider bar in the user application. The slider bar may provide a range for selection. Hence the user application may provide additional control into hands of the sellers.

In addition, if a buyer selects the TRES as their broker instead of a third party, the commission payable on the buy side by the seller may be automatically reduced by a predetermined percentage regardless of their selection on the slider bar. For example, the commission payable may be reduced to 1.5 percent. The TRES may credit a portion of the predetermined percentage as a rebate to the buyer. For example, the TRES may credit 0.5 percent as a rebate to the buyer. The portion of the predetermined percentage being applied as a rebate to the buyer may be determined by the TRES based on a type of membership associated with the buyer. For example, the portion may be higher for a gold membership than for a silver membership.

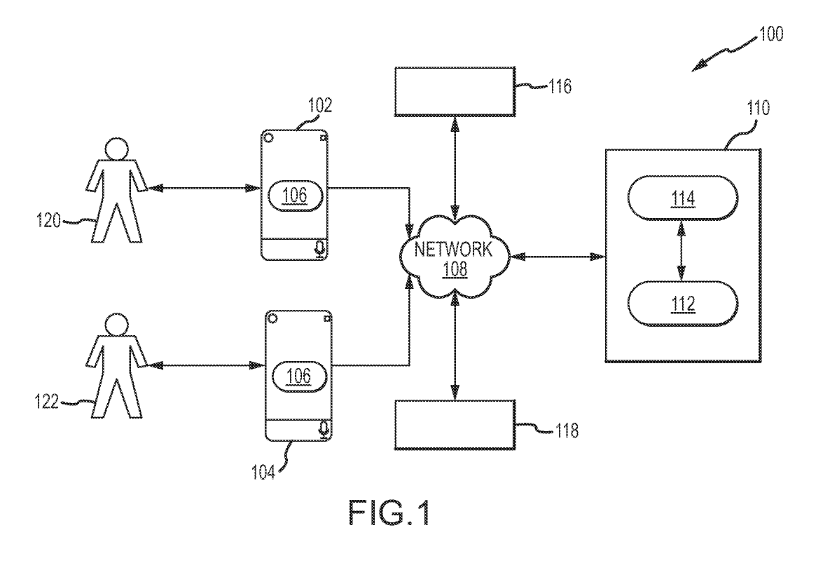

Referring now to the drawings, in which like numerals represent like elements, various embodiments will be described. For example, FIG. 1 illustrates an environment 100 in which methods and systems for managing real estate transaction as described herein may be implemented.

Environment 100 may include user devices 102 and 104, a user application 106, a network connection 108, a server 110, a database 112, a web application 114, and one or more web servers 116, and one or more third party service providers 118. User devices 102 and 104 (each of which may also be referred to as a processing device) may be any device comprising at least one processor and at least one memory/storage. Although only two user devices are illustrated, the reader will understand that TRES is not limited to two devices and that there may be number of user devices as well as any number of buyers and sellers. For example, processing device 102 may include mobile devices such as phones, tablets, laptops, watches, desktop computers, servers, etc. User devices 102 and 104 may communicate with server 110 via network 108. User devices 102 and 104 may further communicate with websites associated third party service providers via network 108.

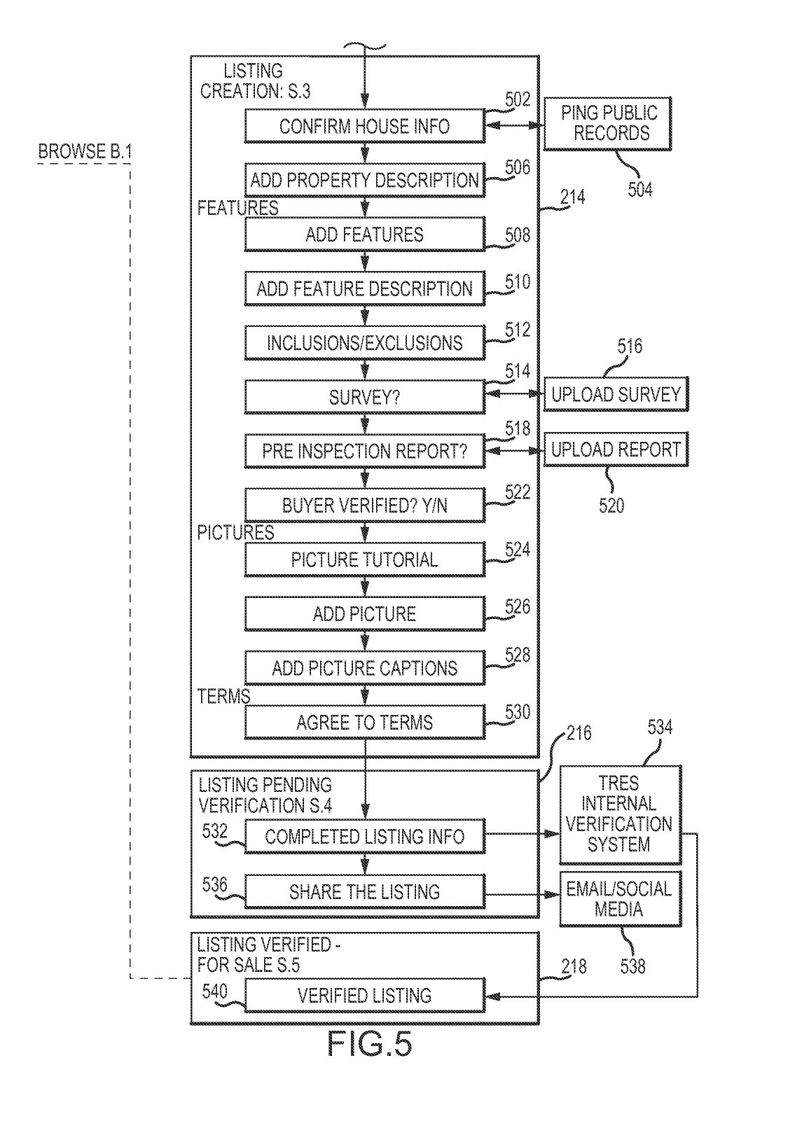

Server 110 may be one or more computing device, such as such as the computing device illustrated in FIG. 5. In one example, server 110 may be a distributed server or a cloud server. Server 110 may include database 112 and web application 114. Alternatively, database 112 and web application 114 may be located on a memory accessible to server 110. Database 112 may be used to store information received from seller 120 and buyer 122. Database 112 may further store instruction information for seller 120 and buyer 122, service providers 118, etc. Web application 114 may process information being received from seller 120, buyer 122, service providers 118, etc. Web application 114 may further update status of the listing on a web page via web server 116.

Network 106 may be any type of network capable of facilitating communications between processing devices 102 and 104, server 110, and web server 116. Examples of such networks include, but are not limited to, LANs, WANs, cellular networks, and/or the Internet. Web server 116 may be one or more computing device, such as such as the computing device illustrated in FIG. 5. In one example, web server 116 may be a distributed server or a cloud server. Processing device 102 and server 110 may communicate with web server 116 via network 108 to access merchant websites. Third party service providers 118 may include one or more providers of services such real estate broker services, financial services, inspection services, verification services, electronic signature services, etc. The services providers 118 may be listed by the TRES or may be added by buyer 122 or seller 120 while transacting for a property.

Application 106 may reside on either one or both processing devices 102, 104 associated with seller 120 and buyer 122 respectively. Application 106 may be downloaded on processing devices 102, 104, and used by sellers and buyers for real estate transaction. Alternatively the functionality of application 106 may be accessed as a web page via browser (not shown) on the processing device 102. This alternative embodiment eliminates the need for a purpose built application 106 to be installed on the device while providing the same functionality to the user. Application 106 may provide buyers and sellers of real estate, a user interface for the transaction. For example, application 106 may provide a first user interface where buyers/sellers can create their profiles, a second user interface where the buyers/sellers can view listings of the properties, a third user interface where a buyer can view additional details of a selected property, a fourth user interface where the buyer can create a packaged offer, etc. In one example, only a thin version of application 104 may reside on processing device 102. For example, the thin version of the application may include basic features and limited information. Once the user selects an option to view additional information, the thin version may request and receive the addition information from server 110.

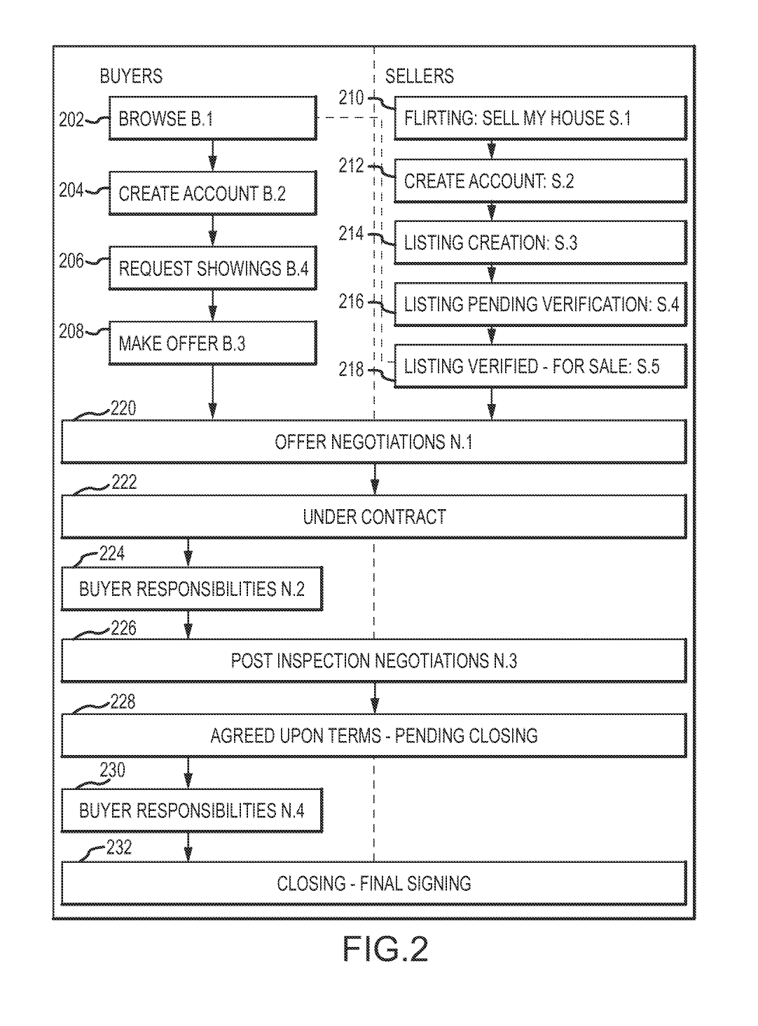

FIG. 2 illustrates an exemplary flow diagram 200 for transaction of real estate as described herein. At operation 202, buyer 122 may browse listing of the properties on application 106. For example, buyer 122 may download application 106 on user device 102 from server 110. After downloading, buyer 122 may initiate application 106. Upon initiation of application 106, it may prompt buyer 122 to provide an area of interest. Once the buyer 122 has provided the area of interest application 106 may send the area of interest to server 110. Server 110 may search all the properties listed in database 112 and provide with a listing of properties in area of interest. Application 106 via browsing screens may display the listing of properties in the area of interest. In one embodiment, buyer 122 need not be registered with the TRES for browsing of properties. While browsing the listing of properties on application 106, buyer 122 may be interested in one or more properties in the listing. When buyer 122 has selected one or more properties he is interested in, application may prompt him to create a user account with the TRES.

At operation 204, buyer 122 may create a buyers account on the TRES using application 106. Application 106 may guide the buyer in creating the user account. For example, application 106 may provide a user interface for creating the user account. The user interface may guide buyer 106 in process of creating of the users account. Buyer 122 may create the buyer's account by entering his identification information such as his name, his address, his driver's license number, etc. Buyer may create login credentials including a user name and a password. The buyer's profile may be stored locally on buyer's device 102 or server 110.

Once buyer 122 has created the user profile, at operation 206 buyer 122 may request showings for the one or more identified properties. For example, once buyer 122 has identified the properties he may view additional information about these identified properties. Once buyer 122 has viewed the additional information, he may request application to schedule showing for a selected property. Application 106 may then provide a request showing interface. The request showing interface may include a calendar interface for scheduling the showing. The request showing interface may further provide seller's preferred time for showings. The request showing interface may allow Buyer 122 to select a date and time matching seller's availability. Once buyer 122 has indicated the showing time, application 106 create a bundled information package and send to seller 120.

At operation 208, after buyer 122 has viewed the property, application 106 may prompt buyer 122 to make an offer. In one embodiment, the TRES may allow the buyer 122 to make offers directly to seller 120 for the properties without requesting showing. For example, application 106 may guide buyer 122 with a process or creating an offer. Application 106 via a user interface may prompt the user to provide an offer price, a purchase type, an amount of earnest money, a closing time, etc. Once buyer 122 has provided sufficient information, application may send the information to server 110. Server 110 may create, based on buyer provided information, a packaged offer. The packaged offer may include the offer price, the purchase type, the amount of earnest money, the closing time, and the terms of the offer. The TRES may send the packaged offer back to application 106 for buyer's review. In review mode, application 106 may display all elements of the packaged offer. Once buyer 122 has reviewed the packaged offer, he may prompt application 106 to send the packaged offer. Application 106 may send the packaged offer to seller 120.

In one embodiment, at operation 212, the TRES may allow seller 120 to consider selling their property. For example, the TRES may allow seller 120 check an estimate value of their property. For example, seller 120 may enter the zip code and address of the property on application 106. The TRES may verify the property address for system coverage. Upon determining that the property address is within the coverage, may prompt seller 120 to provide their expected price. The TRES may determining a market price of the property using a third party and compare the market price with the seller's price. The TRES, based on the comparison, may provide a feedback on how close or far out of market price seller's price is. Seller 120 may not need to have an account with the TRES to acquire this information.

Once the TRES has provided the feedback on the price, at operation 212, seller 120 may proceed to create a sellers account. Seller 120 may create an account by uploading a picture of their driver's license, and providing common contact information of name, email address, physical address. Seller 120 may also upload a picture of themselves to be used in application 106. Application 106 may notify the seller that all sellers are verified by a third party verification system. Seller 120, once verified, may be prompted to sign a seller's listing agreement and agree to the terms and conditions of the TRES. In addition, during account creation, seller 120 may be allowed to choose a level of services that he/she would like to receive from the TRES. The lever of services may include packages, e.g., referred to gold, silver, or bronze, of services may be made available for seller 120 to choose from. The variables in these service packages may include different levels of showing services, professional photography, listing set up, listing management, full service brokerage, cleaning services, or any other service that may be of interest to a real estate seller.

After creating the account, seller 120, at operation 214, may proceed to list his/her property on the TRES. Application 106 may guide seller 120 through the process of listing his property. For example, application 106 may prompt seller 120 to provide information for creating the listing. The TRES may confirm the house information by digitally contacting third party systems. Once the property information in confirmed, application 106 may guide seller 120 through writing their property description, adding features, feature descriptions, inclusions and exclusions, survey results and inspection reports. In addition, application 106 may provide tutorials to seller 120 informing him/her about do's and don'ts of taking pictures of the property. Once pictures are listed, application 106 may allow seller 120 to add captions and labels and tags to the images. Once the listing has been created, the TRES may create a record for the property in database 112 and assign a status to the listing based on a state diagram. The state diagram may be provided by a state machine. The state machine may be a processor.

Once seller 120 has created listing for his/her property and agreed to the terms and conditions, at operation 216, the property may be listed on the web page. The property may be listed with a ‘coming soon’ state. The TRES may not allow any transactions on the ‘coming soon’ listing until it is verified by a TRES verification system. For example for a property under ‘coming soon’ state, offers and showings may not be available to buyer 122, but the listing is visible to any buyer. During the listing pending stage, seller 120 may be allowed to share the listing via email and social media. Once seller 120 has been verified, the state of the listing may be updated from ‘coming soon’ to ‘unverified’. Under the ‘unverified’ state, buyer 122 may be allowed to schedule a showing for the property with a warning message of ‘pending property verification’. Once the address and details of the property is verified, the state of the property may be updated from ‘unverified’ to ‘for sale’. Once the state of the listing is updated to ‘for sale’, seller 120 may be allowed to receive offers for the property.

Once, seller 120 receives an offer for the property from buyer 122, at operation 220, the TRES system may engage buyer 122 and seller 120 in offer negotiations. For example, the TRES may send the offer received from buyer 122 to seller 120 in digital format. Seller 120 may first receive notification and then review the offer. Seller may then accept, counter, or ignore the offer. The TRES may prompt seller 120 to respond within a predetermined time or the offer expires. If seller 120 ignores the offer for the predetermined time, the offer may expire. If seller 120 counters the offer, the TRES may guide seller 120 through setting terms and creating a counter offer, which is then sent back to buyer 122. If seller 120 accepts the offer a third party electronic signature-company may be engaged to create and complete a binding contract that seller 120 signs. The same third party electronic signature-company may then send the contract to buyer 122 for his signature.

If seller 120 counters the offer, the TRES may send the counter offer to buyer 122. Buyer 122 may respond to the counter offer using application 106. Buyer 122 may respond to the counter offer in three possible ways. For example, buyer 122 may decline the counter offer, accept the counter offer, or counter the counter offer. If buyer 122 declines the counter offer, the negotiation is ended. If buyer 122 counters the counter-offer, buyer 122 may be guided through setting terms and creating a counter-counter offer. The TRES may send the counter-counter offer back to seller.

If buyer 122 accepts the counter offer, a third party electronic signature-company may create and complete a binding contract that buyer 122 signs. In addition, the third party may further send the binding contract to the buyer's broker, if applicable. The same third party electronic signature-company may then send the contract to the seller 120 for his/her signature. Buyer 122 and seller 120 thus may exchange an infinite number of offers and counter offers to the point of either abandoning negotiations or coming to terms and signing the contract. Although the number of offers and counter offers may not be limited, but buyer 122 and seller 120 may be provided with a time limit on reaching an agreement. If the parties are not able to reach an agreement within the time limit, the negotiations may be ended by the TRES. When both parties reach an agreement and sign the contract, the state of the property, at operation 222, may be updated from ‘for sale’ to “under contract.”

When the property is ‘under contract’, the TRES, at operation, 224 may send notifications to buyer 122 that he/she needs to provide the earnest money and get the property inspected. Buyer may then use a third party inspection service to inspect the property. The inspection service may provide an inspection report to buyer 122 and the TRES.

Once it has received the inspection report, the TRES may, at operation 226, engage buyer 122 and seller 120 into post inspection negotiations. For example, the TRES may prompt buyer 122 to review the inspection report. Buyer 122, after reviewing the inspection report may accept, counter, or decline the results of the inspection report. Buyer 122 must review the inspection report within a certain time period or the offer expires.

If buyer 122 declines the results of the inspection report the negotiation is ended and no contract is made; the seller now being free to sell to another buyer. The TRES may then change the state of the property from ‘under contract’ to ‘for sale’. If buyer 122 counters the results of the inspection report, the TRES may guide buyer 122 through setting new terms and creating a counter inspection report offer. Once created, the TRES may send the counter inspection report offer to seller 120. The counter inspection report offer may include a discount for any needed repairs or improvements.

In an embodiment, the only option for the buyer is to select a monetary amount to be deducted/discounted from the already agreed on sale price to compensate for the defects identified by the inspection report. In an alternative embodiment, TRES may generate a suggested deduction amount based on the results of the inspection. In yet another embodiment, TRES may automatically generate a non-negotiable ‘take-it-or-leave-it’ deduction amount to the buyer.

In one embodiment, the TRES may allow buyer 122 and seller 120 to exchange an infinite number of offers and counter offers after the inspection to the point of either abandoning negotiations or coming to terms and signing the contract. When both parties agree to the inspection report, an addendum may be created and added to the contract, and the status of the property may be changed from ‘under contract’ to ‘closing ready’. For example, if buyer 122 accepts the results of the inspection report a third party electronic signature-company may create and complete a binding addendum that buyer 122 signs in the system. The same third party electronic signature-company may then send the contract with the addendum to seller 120 for his/her signature. The contract with the addendum may also be sent to the buyer's broker the seller's broker (if applicable) for their signatures.

After the addendum is signed by buyer 122 and seller 120, the TRES, at operation 230, may notify buyer 122 of his/her responsibilities to be ready to close. For example, the TRES may notify buyer 122 that he/she needs to provide proof of funds and the money must be in escrow for the transaction to continue to closing. When all conditions are satisfied, the TRES may send to both buyer 122 and seller 120 contracts to sign. When the contracts are signed, the TRES at operation 232 may mark the contract to be closed and the transaction to be complete. In addition, the TRES may change the state of the property from ‘closing ready’ to ‘sold.’

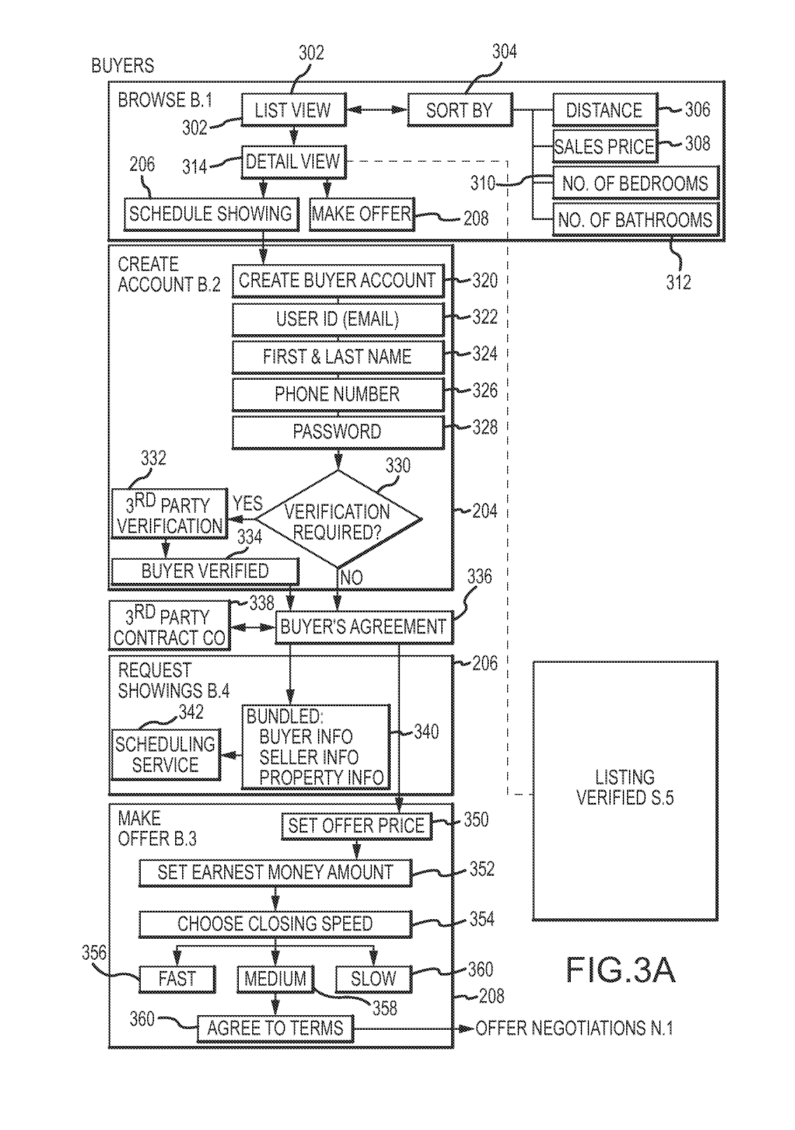

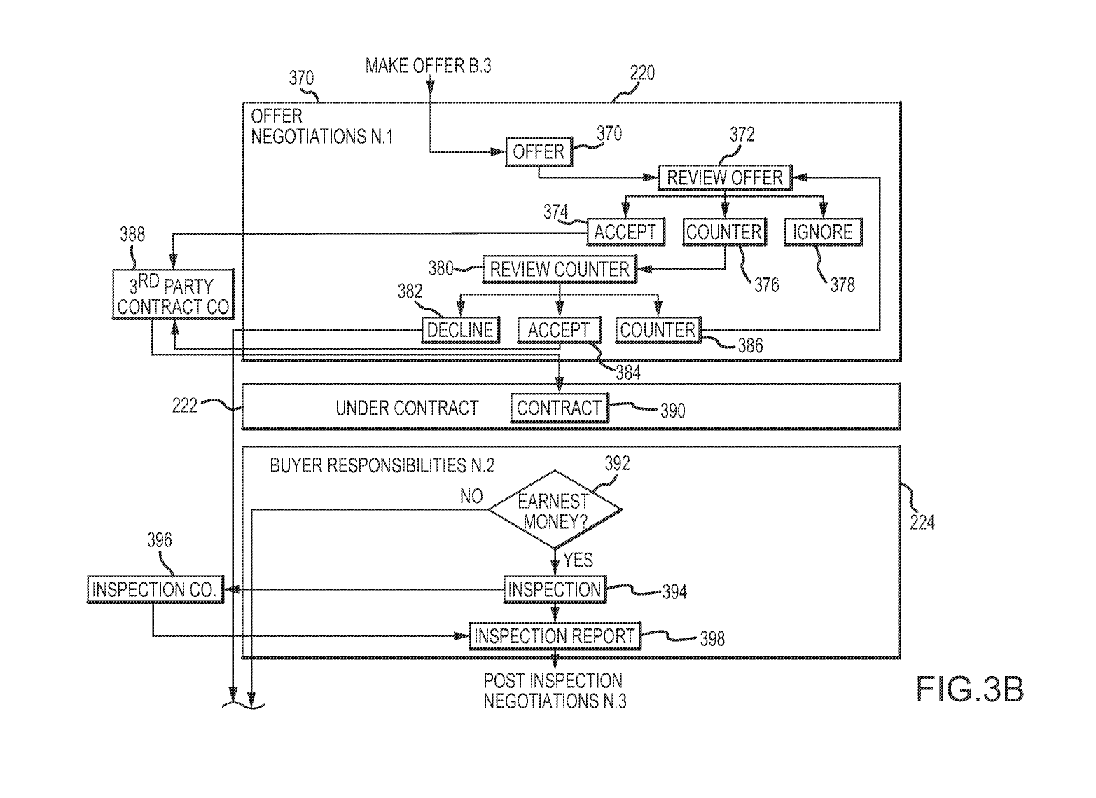

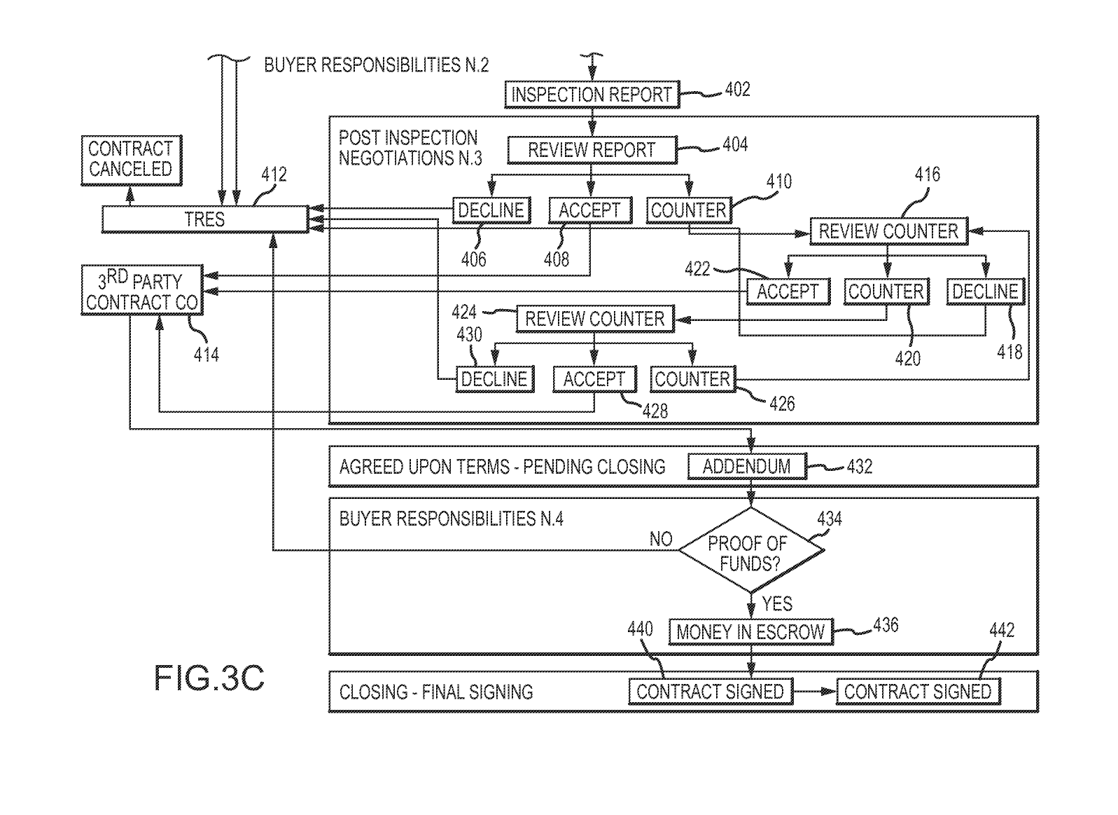

FIG. 3A illustrates an exemplary flow diagram of a buyer's actions associated with a transaction of real estate as described herein. As described above, buyer 122 may initiate the real estate transaction by initiating application 106 on buyer's device 104. Upon initiation, application 106 may prompt buyer 122 to select an area of interest. For example, application 106 may provide a user interface for selecting the area of interest. The user interface may include a map and/or an option to enter an address (or postal code). Buyer 122 can enter his/her area of interest by either providing the postal code or selecting on the map. In one embodiment, application 106 may determine a default area of interest based on a present location of buyer's device 104.

Once, buyer 122 has selected the area of interest, application 106 may determine if the selected area is served by the TRES. If the selected area is not served by the TRES, application 106 may recommend a list of nearby areas which are served by the TRES. Buyer 122 may select the area of interest from the recommended areas. Once buyer 122 has selected the area of interest, at operation 302, application 106 may provide a list view of the properties available in the area. For example, application 106 may send the area of interest selected by buyer 122 to server 110. Server 110 may search for properties listed in the database in the area of interest and send a list of properties to application 106. Application 106 may display the list of properties on buyer's device 104. Application 106 may include basic information about the properties on the list. For example, the list may include a sale price, number of bedrooms, distance, etc. The information displayed in the list view may be filtered by server 110.

Application 106, at operation 304, may provide option for buyer 122 to sort the displayed list of properties. For example, application 106 may provide a user interface to enable buyer 122 to sort the list. The user interface may enable buyer 122 to sort the listing of properties based on distance (operation 306), sale price (operation 308), number of bedrooms (operation 308), number of bathrooms (operation 310), etc. In one example, the sorting options may be determined based on buyer's behavior, such as a frequency of use. In a default view, the listing may be sorted based on distance. Buyer 122 may identify one or more properties from the list he/she is interested in.

After buyer 122 has identified properties he/she is interested in, application 106, at operation 314, may provide a detail view of the identified properties. For example, application 106 may inform server 110 of the properties identified by buyer 122. Server 110 may send detailed information about the identified properties to application 106. Application 106 may display the detailed information on buyer's device 104. In one example, the application 106 may provide, along with the detail information, an option to request a showing (operation 206) and an option to make an offer (operation 208) to buyer 122 for the identified property.

In one embodiment, the detailed view may provide a complete detail of the selected property. For example, the detail view may include but is not limited to: photos, property details, property description, live map, architectural style, interior features, exterior features, lot/site, neighborhood, inclusions/exclusions, surveys and reports. In addition, the detailed view may include a current state and activity of the listing on the TRES. Information shown may further include watchers, views, offers, contracts, days on the system, how popular the listing is and if it is a new listing. A distinct element of the detail listing view may include an ability for a browsing buyer to request showings, share the listing, ask the seller a question and make offers on the property. There are omnipresent buttons at the footer of the detail listing that provide this functionality. In one example in detail view buyer 122 may access a photo gallery screen by swiping on an image in the detail listing view or by swiping on the image of a property on the list view screen. The photo gallery screen may include both an image, a description and description tags that give explanation of what is shown in the image.

In one embodiment, if buyer 122 is not logged in using a buyer's account, application 106 may prompt buyer 106 to create the buyer's account. For example, when buyer selects an option to schedule a showing or make an offer, application 106 may determine whether buyer 122 is logged in via a buyer's account. Upon determining that buyer 122 is not logged in via a buyer's account, application 106, at operation 320 may prompt buyer 122 to create a buyer's account. The account creation section of the TRES may provide account users an ability to sign up and become verified users of the TRES system.

To create an account the TRES may require buyer to provide personal information. Application 106 may display a form and guide buyer 122 to create the buyer's account. For example, application 106, at operation 322, may prompt buyer 122 to create a user ID. The user ID may simply be an email address of buyer 122. At operation 324, application 106 may prompt buyer 122 to provide his first and last name. At operation 326, application 106 may prompt buyer 122 to provide his contact number. At operation 328, application 106 may prompt buyer 122 to create a passcode. In addition, application 106 may prompt buyer 122 to provide at least one authorized identification. For example, application 106 may prompt user to provide a driver's license number. In one embodiment buyer 122 may include a profile picture and may edit buyer's information.

After buyer 122 has provided login information, application 106, at operation 330, may determine whether verification is required for buyer 122. For example, application 106 may determine if buyer 122, based on provided information, needs to be verified. If application 106 determines that buyer 122 needs to be verified, it may leverage a third party verification from one of the service providers 118 to verify identity of buyer 122. For example, at operation 332, application 106 may send buyer's information to third party verification services. The third party verification services may enter results of verification to the TRES. At operation 338, the TRES may notify application 106 that buyer 122 is verified.

In one embodiment, if buyer 122 fails the third party verification, the TRES may allow them to continue in system, but they cannot transact without further verification processes. If buyer 122 passes the third party verification, he/she may be allowed to take any action he/she want in the TRES (i.e. request showings, make offers, negotiate and get under contract.) When verification is complete, buyer 122 may be prompted by application 106 if he/she is represented by a broker or if he/she wants the TRES to represent him in the process of purchasing the identified property. If buyer 122 select “represented by a broker,” then application 106 may prompt buyer 122 to provide information about the broker. If buyer 122 selects that he/she wants the TRES to represent him/her, then he/she may be prompted by application 106 to sign a transactional contract with the TRES. The TRES may present buyer 122 with a digital version of the contract that can be signed in the system (using various 3rd party electronic signature systems.) Additionally, the TRES may verify the identity of the person that is using application 106 and that individual is the owner of record of the property he/she is trying to sell.

Once buyer 122 has been verified, at operation 336, application 106 may generate a buyer's listing agreement. Alternatively, the buyer's listing agreement may be generated by server 110 based on the buyer's information and sent to application 106. Application 106 may prompt buyer 122 to provide his assent to the buyer's listing agreement. Buyer 122, at operation 338 may use a third party for electronically signing the buyer's listing agreement.

Once, buyer 122 has assented to the buyer's listing agreement, application 106 may prompt buyer 122 to request a showing. For example, application 106 may provide a user interface showing availability of seller 106 to conduct a showing. Once buyer 122 selects the time and date for showing, at operation 340, application 106 may prepare bundled information. The bundled information may include buyer information, seller information and property information. At operation 342, application 106 may send the bundled information to scheduling services. For example, application 106 may send the bundled information to a broker or a third party hired by seller 120 for showing the property to buyer 122.

In one embodiment, application 106 may provide a request showing screen to buyer 122. The request showing screen may provide the functionality for buyer (or any user) to request a showing of a property. Buyer 122 may select a ‘request showing’ option on a detail list screen and may be directed to a request showing screen. Upon selection of the request showings option, buyer may be navigated to a request showing screen. On the request showing screen, at operation 342, buyer 122 may select a scheduling service. The scheduling service may allow buyer 122 to select a date and time to view the property. Buyer 122 may submit and confirm the request time to the TRES. Once buyer 122 has selected the date and time for request showing, application 106 may send a notification to seller 120 (or designated showing service or a TRES staff member). The notification may also include bundled information.

Seller 120 may launch application 106 on seller device 104. Inside application 106, seller 120 (or designated showing service or the TRES staff member) may view and either accept the showing request or send a message back (within the TRES system) with a different time that would work to show the property. Buyer 122 and seller 120 (or the designated showing service or the TRES staff member) may message back and forth an indefinite number of times to determine a time to show the property. These back and forth messages may be logged in a library and may be accessed by either party in the messaging thread.

Once buyer 122 has seen the property, application 106 may prompt buyer 106 to create an offer. For example, application 106 may provide a buyer's negotiation screen on buyer's device 104. The buyer negotiation screen may provide the functionality for buyer 122 to make offers directly to seller 120 of the identified property in the TRES. The TRES may allow buyer 122 to negotiate key terms (price, earnest $, multiple dates) in the application 106 and then issue final contract for signature only. In one embodiment when browsing listings, buyer 122 may make offers in one click by clicking a “Make Offer” button provide along with listings.

To create the offer, application 106 may prompt buyer 122 with a tutorial screen. The tutorial screen may provide buyer 122 instructions about steps that make up a full offer. On click through, buyer 122 may be taken to a create offer screen where he/she may begin to assemble the offer step by step. When each section in the create offer screen is complete, buyer 122 may be able to submit the offer. On the create offer screen, to aid buyer 122, incomplete sections may be noted with grey icons and complete sections may be noted with green icons and check marks.

In the process of creating the offer, at operation 350, application 106 may prompt buyer 122 to set an offer price. Setting the offer price may be considered to be a first step in creating an offer. Application 106 may guide buyer 106 in setting the offer price. For example, application 106 may provide examples of offer prices of similar properties in the area. In addition, application 106 may provide an option of engaging a third party to estimate the offer price for the property.

Once buyer 122 has set the offer price, application 106, at operation 352, may prompt buyer 122 to set earnest money amount. Buyer 122 may set the earnest money amount by selecting an offer type. Application 106, depending on selection of the offer type, may determine and show the earnest money in real time on buyer screen. Hence, selecting offer type is the second step in creating an offer. Buyer 122 may be provided with two options for the purchase type. For example, the purchase type may be either a cash or mortgage offer. If the purchase type is a mortgage offer, then seller 120 may determine a percentage of a down payment. In application 106, the down payment percentage may default to 20%. The other available percentage amounts are: 10%, 20%, 25%, 30%, 35%, 40%, 45%, and 50%. When buyer 122 or seller 120 changes the amount of the down payment, application 106 may calculate and provide the cash amount in real-time on screen. If the offer is a cash offer the other options on the page may not be available. If seller 120 has no changes to the default, he may return to the Create Offer screen and move on to the next step and the purchase type selection is considered complete.

Once, buyer 122 has set the earnest money amount, application 106, at operation 354 may prompt buyer 122 to choose a closing speed. Choosing the closing type may be a third step in creating the offer. Application 106 may provide options to buyer 122 to choose from for the closing speed. The options may include a fast closing option, a medium closing option and a slow closing option. For example, at operation 356, application 106 may provide a fast closing option, at operation 358 may provide a medium closing option, and at operation 360 may provide a slow closing option. The fast closing option may be an expedited closing option. The medium closing option may be a standard closing option, and the slow closing option may be a ground closing option. The expedited or fast closing option may only be available to buyer 122 when he chooses a cash offer purchase type. In addition, application 106 may dynamically show three dates for each setting speed, earnest money/ proof of funds, commitment date, and closing date. When buyer 122 changes between the closing speeds the dates may change in real time. The closing date may be shown as either an exact date or referred to as a close date “on or before” a certain date.

After receiving a selection of the closing option, application 106, at operation 362 may prompt buyer 122 to agree to terms of the offer. The terms of the offer may be displayed on buyer's device for him/her to review. After buyer 122 has agreed to the terms of the offer, a final step in creating the offer is sending seller 120 a text note. Sending a text note to seller 120 may be an optional step and application 106 considers and marks it complete from the beginning

When all these steps are complete, application 106 may mark a create offer screen as complete and may prompt buyer 122 that the offer is ready to be previewed. For example, after completion of all elements of the offer, application 106 may provide a ‘preview offer’ option on the create offer screen. In one embodiment, after the user has provided input to all element of the offer, a text on the button may shift from ‘incomplete offer’ to ‘preview offer’. Buyer 122 may use the preview offer option to preview the offer before it is sent to seller 120. When buyer 122 selects the preview offer option, application 106 may navigate buyer 122 to a ‘preview offer screen.’ The preview offer screen may show all the elements of the offer in detail. In addition, application 106 may allow buyer 122 to navigate back to the create offer screen from the preview offer screen and make changes if he/she desires to one or more elements of the offer.

Once buyer 122 has previewed the offer, the offer may be ready to be sent to seller 120. For example, after buyer 122 has previewed the offer, application 106 may provide a ‘send offer’ option on the preview offer screen. When buyer 122 selects the send offer option, application 106 may send the offer through the TRES to seller 120. If the offer is not sent successfully, then buyer 122 may be shown a failed send alert screen and may then be returned to the preview offer screen. If the offer is successfully sent, buyer 122 may be shown a successful send alert screen. Moreover, when the offer is successfully sent, application 106 may navigate buyer 122 to a buyer pre-contract board. In one embodiment, the buyer's view in the TRES may default to the buyer pre-contract board where buyer 122 may have a complete view of all the steps in the negotiation process.

The buyer pre-contract board may show the property in negotiation, the avatars of buyer 122 and seller 120, a list of all current, future and past steps for the negotiation process, a ‘call to action’ message field with detailed information about the current, future or past steps, and a countdown timer. All offers may have a countdown timer for deliverables. The countdown timers may be synchronous to a date (set to expire on times and dates—11:59:59) or synchronous to an event (set to expire in a set period of time from an action taken by the other party in the negotiation.) If the offer ‘times out’ buyer 122 may be sent a ‘time out’ notification. On click through, buyer 122 may be shown an ‘expired offer pre-contract board’. The expired offer pre-contract-board may include a visual representation with a text description of where the negotiations stopped. Buyer 122 may click through to see a detailed view of the expired offer. From there buyer 122 may restart the create offer process. If the offer is rejected by seller 120, buyer 122 may receive a notification in the TRES of the rejection. Buyer 122 may click through to see the detailed view of the rejected offer.

Once buyer 122 has created and sent the offer to the seller 120, application 106, at operation 370, may send the offer and notification for the offer to seller 120. When the offer is sent by buyer 122, seller 120 may receive a notification that he/she has received an offer. Seller 120 may receive the notification either via email or on seller's device 102. Seller 120 may also receive the notification in application 106 on seller's device 102. The notification may include the address and visual of the property, the avatar of buyer 122, high-level information of the terms being negotiated and a countdown timer that counts down to zero.

After sending the offer and notification for the offer to seller 120, application 106 at operation 372 may prompt seller 120 to review the offer. For example, application 106 may provide a seller review offer screen. The seller review offer screen may show the address and visual of the property, buyer's avatar, detailed information of the terms being negotiated and a countdown timer. The seller view may be unique from the buyer's view because the seller view may show a ‘gross proceeds’ section with a breakdown of fees, taxes, and the total of proceeds that seller 120 may receive if the offer is accepted as is.

Application 106 may prompt seller 120 to respond to the offer and may provide response options for the offer. For example, at operation 374, application 106 may provide a accept offer response. At operation 376, application 106 may provide a counter offer response and at operation 378 may provide a accept offer response. In the seller view review offer screen, application 106 may provide three selection options corresponding to the three options for seller 120. Seller 120 by selecting one of the three options displayed on seller's device 102 may accept the offer, create a counter offer or reject the offer. Application 106 may prompt seller 120 to respond within a certain time period or the offer expires. If seller 120 rejects the offer, a notification may be sent to buyer 122 and the negotiation process may start over. If seller 120 counters the offer, application 106 may navigate seller 120 to a create counter offer screen. Application 106 via the create counter offer screen may guide seller 120 in setting new terms of the counter offer. The counter offer screen may show the previous offer on top of the create counter offer screen as a reference. Seller 120 may change any aspect of the terms of the previous offer to create the counter offer.

In one embodiment, the first step in creating the counter offer may include reviewing and possibly adjusting a counter offer price. Application 106 may display the previous offer price on the create counter offer screen as a reference. The second step in creating the counter offer may include reviewing and possibly adjusting the purchase type of the previous offer. The create counter offer screen settings may show the purchase type from the previous offer. Application 106 may allow seller 106 to adjust the purchase type from the previous offer. If seller 120 makes adjustment to any element of the purchase type of the previous offer, the previous terms may still be marked. For example, when seller 120 changes the amount of the down payment, the cash amount may be re-calculated in real time on the create counter offer screen.

The third step in creating the counter offer may include for seller 120 to review and possibly adjust the closing timeline or closing speed from the previous offer. Again, seller 120 may be provided with three options to choose from for the closing speed: expedited (fast), standard (medium), and ground (slow.) The expedited (fast) option may only be available for the cash offers. The create counter offer screen may show three dates for each setting, the earnest money/ proof of funds, commitment date, and closing date. If seller 120 makes adjustment to any element of the closing timeline, the previous terms are still marked visually on the create counter offer screen. When seller 120 changes between closing speeds, the dates may change and be reflected in real time on the create counter offer screen. Similar to the create offer screen, the closing date may be shown as either an exact date or referred to as a close date “on or before” a certain date on the create counter offer screen. The final step in creating the counter offer may include replying to buyer 122 with a text note. The create counter offer screen may provide a message space where seller 120 may create a message for buyer 122. The creating of text note for buyer 122 may be an optional step.

When all these steps are complete, application 106 may provide an option for seller 120 to preview the counter offer. For example, once seller 120 has provided input to all elements of the counter offer, a preview counter offer option may be highlighted on the create counter offer screen. For example, upon completion of the counter offer, a text on the button may shifts from ‘incomplete counter offer’ to ‘preview counter offer’. Upon selection of the preview counter offer option, application 106 may navigate seller 120 to the preview counter offer screen. The preview counter offer screen may show all the elements of the counter offer in detail and may provide an option to send the counter offer to buyer 122. In addition, application 106 may allow seller 120 to navigate back to the create counter offer screen from the preview counter offer screen and make changes if he/she desires.

The preview counter offer screen may further provide a send counter offer option. When seller 120 selects the send counter offer button, application 106 may send the counter offer through the TRES to buyer 122. If the counter offer is not sent successfully, then application 106 may show seller 120 a failed send alert screen and navigate seller 120 to the preview offer screen. If the counter offer is successfully sent, application 106 may show seller 120 a successful send alert screen.

When the counter offer is successfully sent to buyer 122, application 106 may navigate seller 120 to a seller pre-contract board. The seller pre-contract board may provide a complete view of the negotiation process. The seller pre-contract board may show the property in negotiation, the avatars of buyer 122 and seller 120, a list of all current, future and past steps for the negotiation process, a message board with detailed information about the current, future or past steps, and a countdown timer. All offers may have a countdown timer for deliverables. The countdown timers may be synchronous to a date (set to times and dates 11:59:59) or synchronous to an event (set to an action that occurred by the other party.)

If seller 120 accepts buyer's offer, application 106 may send an alert to buyer 122. In addition, when seller 120 accepts the buyer's offer, the TRES may simultaneously send alerts to seller 120 and the transactional broker assigned to the transaction. The message to the transactional broker may notify them that terms have been agreed upon and that the next step is for all parties involved to sign the contract. The TRES may have a capability to sign in application 106 any contract needed to facilitate the transaction of property. Seller 120 may be sent a notification with the terms of the contract and the next steps to be taken. Seller 120 may be provided with an in-house or third party electronic signature capture screen where seller 120 may review the contract and sign and initial the contract in application 106. This system within the TRES may create and complete a binding contract all parties will sign to complete the process of putting the property under contract.

Upon signing of the contract by seller 120, if buyer 122 has not signed the contract, seller 120 may be navigated back to the seller pre-contract board. When buyer 122 signs the contract, seller 120 may receive a notification that he/she may now be under contract and that he/she will be navigated to a seller post-contract board. When seller 120 has signed the contract and if buyer 122 has also signed the contract, seller 120 may be navigated to the seller post-contract board. The seller post-contract board may include instructions and details of the steps seller 120 must take to keep the contract in good standing for closing to occur.

Similarly, creation of the counter offer by seller 120, application 106 may send a buyer notification to buyer 122. The buyer notification may include the terms of the contract and steps to be taken by buyer 122. Moreover, buyer 122 may be provided with an in-house or third party electronic signature-capture screen. On the electronic signature-capture screen buyer 122 may review the counter offer and sign and initial it in application 106. This system within the TRES may create and complete a binding contract the buyer 122 and seller 120 will sign to complete the process of putting the property under contract.

In one embodiment, if buyer 122 has signed the contract and seller 120 has not signed the contract, buyer 122 may be navigated back to a buyer's pre-contract board. In addition, when buyer 122 has signed the contract and seller 120 has also signed the contract, seller 120 will receive a notification that they are now under contract and seller 120 may be navigated to the seller's post-contract board and buyer 122 may be navigated to a buyer's post-contract board. The buyer's post contract board may have instructions and details of the steps buyer 122 must take to keep the contract in good standing for closing to occur.

The Transactional Broker is sent a similar message with in the TRES notifying them of the terms of the contract for them to review. The broker can accept and sign the terms of the contract or reject the contract. Only when the Transaction Broker signs the contract, will the Buyer and seller be sent notification of the property being under contract and the post contract leader boards will become available for viewing.

In one embodiment, when seller 120 creates a counter offer to buyer's original offer, application 106 may send a notification for the counter offer to buyer 122. In addition to the notification application may also send the counter offer to buyer 122. Application 106, after sending the counter offer, may prompt buyer 122 to review and response to the seller's counter offer. For example, application 106 may navigate buyer 106 to the buyer pre-contract board. The buyer pre-contract board may provide buyer 122 with capability to respond to the counter offer from seller 120. The pre-contract board may provide details of the counter offer and a countdown timer.

Application 106, at operation 380, may provide an option to review the counter offer on the pre-contract board. Upon selection of the review counter option, application 106 may navigate buyer 122 to a ‘buyer view review offer screen’. The buyer view review offer screen may show the address and visual of the property, the other party's avatar, detailed information of the terms being negotiated and a countdown timer. Moreover, the buyer view preview option screen may provide at least three action options for buyer 122. For example, at operation 382, application may provide a decline option, at operation 384 may provide an accept option, and at operation 386 a counter option. These action options may be provided in a footer of the buyer view review offer screen as three buttons with three action options. Buyer 122 through selection of the action options may accept the counter offer, create a counter-counter-offer, or reject the counter offer. Application 106 may prompt buyer 122 to respond within a certain time period or the counter offer expires.

If buyer 122 selects the reject option for the counter offer, application 106 may send a notification to seller 120. If buyer selects counter option to the counter offer, application 106 may navigate buyer 122 to the create counter screen where buyer 122 will be walked through setting new terms of the counter-counter offer. The previous offer (i.e. the counter offer from seller 106) may be shown in the buyer's create counter offer screen as a reference. Buyer 122 may change any aspect of the terms of the previous counter offer. For example, and as stated previously, the first step in creating the counter-counter offer is to review and possibly adjust the counter offer price. The buyers create counter offer screen may show the counter offer price as a reference.

The second step in creating an offer is to review and possibly adjust the ‘purchase type. The buyer's counter offer screen may display the purchase type from the counter offer. Application 106 may allow buyer 122 to make adjustment to the purchase type of the counter offer. If buyer makes adjustment to any element of the purchase type, the counter offer terms may still be marked, and other elements of the purchase type may dynamically be recalculated and displayed on the buyers counter offer screen. For example, when buyer 122 changes the amount of the down payment, the cash amount is calculated and displayed in real time on the buyers create counter offer screen.

The third step in creating the counter-counter offer may include for buyer 122 to review and possibly adjust the ‘closing timeline’ or ‘closing speed’ of the counter offer. Application 106 may provide the three options to choose from for the closing speed. For example, these elements may include expedited (fast), standard (medium), and ground (slow.) If buyer 122 makes adjustment to any element of the closing speed, the previous terms are still marked. When buyer 122 changes between closing speeds, the dates may change in real time. The final step in creating an offer is replying to seller 120 with a text note. The buyers create counter screen may allow buyer 122 to include the text note.

When all these steps are complete the buyers create counter offer screen may indicate to buyer 122 that the counter-counter offer is complete and the counter-counter offer may be previewed. When buyer 122 selects the preview option, application 106 may navigate buyer 122 to a preview offer screen. The preview offer screen may display all the elements of the counter-counter offer in detail and provide an option to send the counter-counter offer to seller 120. The preview offer screen may allow buyer 122 to navigate back to the buyer's create counter offer screen from the preview offer screen and make changes if he/she desires.

Buyer 122 may preview the counter-counter offer and send it to seller 120. For example, the buyer's create counter offer screen may provide an option to send the counter-counter offer to seller 120. When buyer 122 selects the send counter-counter offer option, application 106 may send the counter-counter offer through the TRES to seller 120. If the counter-counter offer is unsuccessfully sent, then buyer 122 is shown the failed send alert screen and is then navigated back to the preview offer screen. If the counter-counter offer is successfully sent, buyer may be navigated to the successful send alert screen.

When the counter-counter offer is successfully sent to seller 120, the buyer view defaults to the buyer pre-contract board where buyer 122 has a complete view of the negotiation process. The counter-counter offer may show up to seller 120 in a notification and the process described in operations 370-386 may begin again. In one embodiment, buyer 122 and seller 120 may counter-offer the terms of the contract an infinite number of times.

The third option is for buyer 122 to accept the counter-offer from seller 120. If the counter-offer is accepted, the TRES may simultaneously send alerts to buyer 122, seller 120, and the transactional broker assigned to the transaction notifying them that terms have been agreed upon and that the next step is for all parties involved to sign the contract. Seller 120 may be sent a notification with the terms of the contract and the next steps to be taken. Seller 120 may further be provided with an in-house or third party electronic signature capture screen where seller 120 may review the contract and sign or initial the contract in application 106. This system within the TRES may create and complete a binding contract all parties will sign to complete the process of putting the property under contract. Upon signing the contract if the other parties have not signed the contract, seller 120 may be navigated back to the pre-contract board. When the other parties sign, seller 120 may receive a notification that they are now under contract and they will be sent to the post-contract board.

Upon signing the contract if the other parties have signed the contract, seller 120 is sent to the post-contract board. The post contract board may have instructions and details of the steps seller 120 must take to keep the contract in good standing for closing to occur.

Buyer 122 is sent a notification with the terms of the contract and the next steps to be taken. On click thought buyer 122 may be provided with an in-house or third party electronic signature-capture screen where the user can review the contract and sign and initial the contract in application 106. This system within the TRES will create and complete a binding contract all parties will sign to complete the process of putting the property under contract.

Upon signing the contract if the other parties have not signed the contract, buyer 122 is navigated back to the pre-contract board. When the other parties sign, seller 120 will receive a notification that they are now under contract and they will be sent to the seller post-contract board. Upon signing the contract if the other parties have signed the contract, seller 120 is sent to the seller post-contract board. The seller post contract board has the instructions and details of the steps seller 120 must take to keep the contract in good standing for closing to occur.

The transactional broker may be sent a similar message within the TRES notifying them of the terms of the contract for them to review. The transactional broker may accept and sign the terms of the contract or reject the contract. Only when the transaction broker signs the contract, will buyer 122 and seller 120 be sent notification of the property being under contract and the post contract leader boards will become available.

In one embodiment, the TRES system may continue to message both buyer 122 and seller 120 and update the post-contract boards until the contract is signed at title and the property transaction is complete. The TRES allows all third parties involved in the closing cycle to login and update statuses. A title company can log in and update status of transaction (i.e. the earnest money was received). An inspector can log in and put in inspection faults. A lender can login and update status of loan. Including the requesting of documents. An appraiser and login and upload appraisal reports. The TRES system allows for any aspect of the contracts to be adjusted to facilitate the transaction RE: amend/extend. Change closing date, change purchase price, changing inclusions and exclusions.

For example, when the property is under contract, application 106 may send notification to buyer 122 that buyer 122 needs to provide the earnest money and have the property inspected. Buyer 122 then may use a third party inspection service to inspect the property. The inspection service, at operation 402 may provide an inspection report to buyer 122 and the TRES system.

Once the inspection service has provided the inspection report, buyer 122 at operation 404, may digitally reviews the inspection report. Application 106 may navigate buyer 122 to a review inspection report screen. The review inspection report scree may provide action options to buyer 122 for the inspection report. For example, the review inspection screen may, at operation 406 provide a decline option, at operation 408 provide an accept option, and at operation 410 provide a counter option. Buyer 122 thus may accept, counter, or decline results of the inspection report by selection an action option on the review inspection screen. Upon selection of an option screen by buyer 122, application 106 may send a notification to seller 110 of the buyer's selection. Application 106 after sending the notification, may prompt seller 120 to respond to the inspection report within a pre-determined time period or the offer expires.

Upon receipt of the notification, seller 120 may access the inspection report and buyers action selection on a review. For example, if buyer 122 declines the results of the inspection report the negotiation is ended. Application 106, at operation 412 may send a notification to the TRES for end of negotiations. The TRES may then cancel the contract and update status of the property in database 112 from ‘under contract’ status to for ‘sale status’. If buyer 122 accepts the inspection report, application 106, at operation 414, may send a notification to the third party contract company for creating the contract.

If buyer 122 counters the results of the inspection report, application 106 may guide buyer 122 through steps of setting new terms and a counter inspection report offer is created. Application 106 may send the counter inspection report offer to seller 120. The counter inspection report offer may include a discount for any needed repairs or improvements.

After application 106 has sent the counter inspection report offer to seller 120, application 106, at operation 416, may navigate seller 120 to a review counter inspection report offer screen. The review counter inspection report offer screen may provide action options to seller 120 regarding the counter inspection report offer. For example, the review counter inspection report offer screen may, at operation 422 provide an accept option, at operation 424 provide a counter option, and at operation 418 provide a decline option. Seller 120 may select one of the action options from the review counter inspection report screen.

If seller 120 selects decline option, the negotiations for the property may end and application 106, at operation 412, may send a notification to the TRES that the negotiation has ended. The TRES may then cancel the contract and update the state of the property in database 112 from ‘under contract’ to ‘for sale’. If seller 120 accepts the counter inspection report offer from buyer 122, application 106, at operation 414, may send a notification to the third party contract company for creating the contract.

If seller 120 counters the counter inspection report offer of buyer 122, application 106 may guide seller 120 through steps of setting new terms and creating a counter-counter inspection report offer. For example, seller 120 may change one or more terms of the buyer's counter inspection report offer or create a new counter-counter inspection report offer. Application 106 may send the counter-counter inspection report offer to seller 120.

After application 106 has sent the counter-counter inspection report offer to buyer 122, application 106, at operation 424, may navigate buyer 122 to a review counter-counter inspection report offer screen. The review counter-counter inspection report offer screen may provide action options to buyer 122 regarding the counter-counter inspection report offer. For example, the review counter-counter inspection report offer screen may, at operation 426 provide a counter option, at operation 428 provide an accept option, and at operation 430 provide a decline option. Buyer 122 may select one of the action options from the review counter inspection report screen.

For example, if buyer 122 declines the results of the counter-counter inspection report offer the negotiation is ended. Application 106, at operation 412 may send a notification to the TRES for end of negotiations. The TRES may then cancel the contract and update the state of the property in database 112 from ‘under contract’ to ‘for sale’. If buyer 122 accepts the counter-counter inspection report offer, application 106, at operation 414, may send a notification to the third party contract company for creating the contract.

If buyer 122 counters the counter-counter inspection report offer, application 106 may guide buyer 122 through steps of setting new terms and a creating a counter-counter-counter inspection report offer. Thus, the TRES may allow buyer 122 and seller 120 to exchange an infinite number of offers and counter offers after the inspection to the point of either abandoning negotiations or coming to terms and signing the contract.

When both buyer 122 and seller 120 agree and sign an inspection report document, at operation 432, an addendum may be created for the inspection report and added to the contract. For example, if buyer 122 accepts the results of the inspection report, the third party electronic signature-company may create and complete a binding addendum that buyer 122 signs in the system. The same third party electronic signature-company may then send the contract with the addendum to seller 120 for his signature.

After the contract with the addendum is signed by both buyer 122 and seller 120, buyer may be notified of his/her responsibilities to be ready to close. For example, TRES, at operation 434, may notify buyer 122 to provide proof of funds. Moreover, the TRES, at operation 436, may notify the buyer to provide the earnest money in an escrow account for the transaction to continue to closing. When all conditions are satisfied, the TRES, at operation 440, may then send both buyer 122 and seller 124 contracts to sign. When, at operation 442, contracts are signed by both buyer 122 and seller 120, the TRES may mark the contract as closed and the transaction to be complete. In addition, the TRES may update the state of the property from ‘under contract’ to ‘sold’. The change of the state of the property may similarly be reflected on the web page.

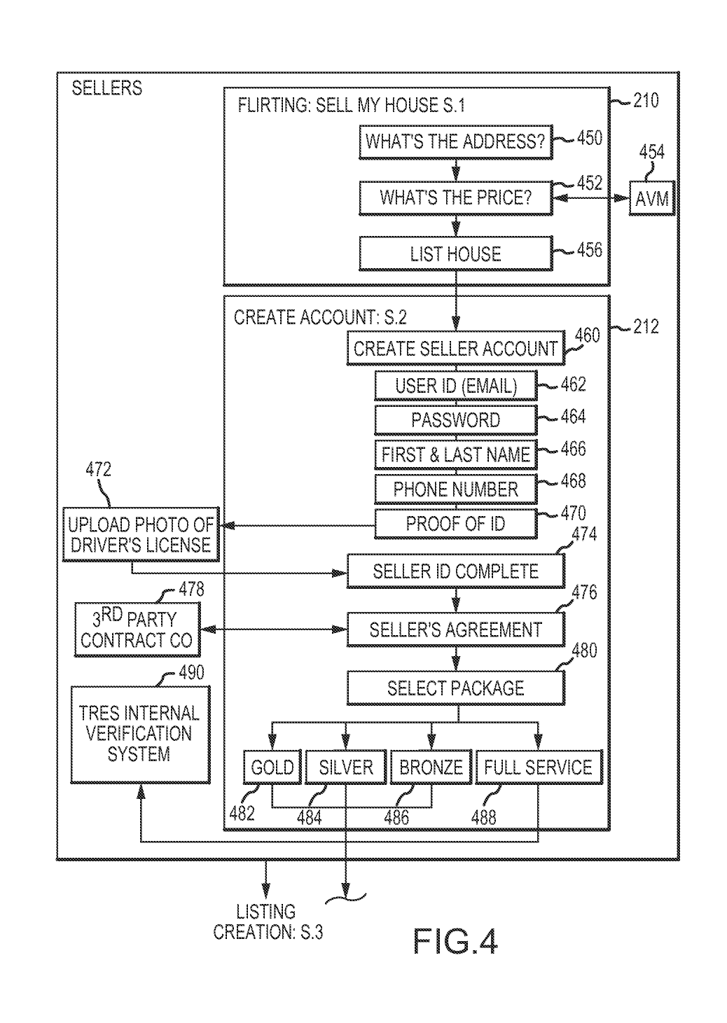

FIG. 4 illustrates an exemplary flow diagram of an account creation associated with transaction of a real estate as described herein. In one embodiment, application 106 may guide buyer 122 and seller 120 through the account creation. For example, if seller 120 is considering selling his/her property, application 106 at operation 450, may prompt seller 120 to enter an address of the property. In addition, application 106, at operation 452 may prompt seller 120 to prove an offer price for the property. If the property is an AVM, application 106 may prompt the seller to provide AVM specification.

The account creation section of the TRES may be similar for both buyer 122 and seller 120. By creating an account users may become verified users of the TRES. To create an account, application 106 may prompt user to provide personal information and upload a picture for use as an avatar in the TRES. For example, application 106, may prompt, at operation 460 to select account, at operation 462 to provide user id (or email address), at operation 464 to create a password for the account, at operation 466 to provide first and last names, and at operation 468 to provide a phone number.

In addition, at operation 470, application 106 may prompt the user to provide a proof of photo identity (ID). At operation 472, application 106 for example may allow the user to upload photo of his driver's license. Once the user has provided the personal information, application 106 at operation 474 may determine if the user ID is complete. Once the user ID is complete, application 106 may provide a seller's listing agreement (buyer's listing agreement for a buyer's account). At operation 478, the user may sign his/her listing agreement using a third party signature service provider. Once the user has signer the user's listing agreement, application 106, at operation 480, may prompt the user to select one of the service packages. Application 106 may display a list of available service packages and user may be selected to select one of the displayed packages. For example, application 106, at operation 482 may display gold package, at operation 484 may display silver package, at operation 486 may display bronze package, and at operation 488 may display gold package. Once the user has selected one of the displayed packages, at operation 490, application 106 may send the user information to the TRES verification system.

In one embodiment, the TRES may leverage a third party verification system to verify the identity of users. If a user fails the third party verification, the TRES may allow them to continue in the system, but they cannot transact without further verification processes. If the user passes third party verification, they may be allowed to take any action they want in the system (request showings, make offers, negotiate and get under contract). When verification is complete, users may be asked if they are in the system to buy or sell. If they are in application 106 to sell, then they are prompted to continue with the listing creation process. If they are in the system to buy, they may be asked if they are represented by a broker or if they want a TRES broker service to represent them in the process of purchasing a property. If the user selects ‘represented by a broker,’ then the user may be asked to enter the information of their broker. If the user selects that they want the TRES broker service to represent them, then they are asked to sign a transactional contract with the TRES broker service. The TRES may present the user with a digital version of the contract that may be signed in the system (using various 3rd party electronic signature systems). Additionally, the TRES may verify an identity of the user that is using application 106 and verify that the individual is the owner of record of the property they are trying to sell.

FIG. 5 illustrates an exemplary flow diagram of listing creation associated with transaction of a real estate as described herein. The listing creation may provide a process for verified sellers to list their properties. The TRES may guide seller 120 through each step in the process with tutorial screens that provide information on how to use application 106, do's and don'ts, and general guidance. The tutorials may be provided in the form of text and video instructions and examples. Throughout the process, seller 120 may preview their listing. The information in the tutorials may be presented in the form of advice coming from a real-estate broker. The content of the tutorials may be written in the voice of the broker and may be represented by a digital avatar.

Application 106, for creating the listing, may provide a form. The form may be provided as a property listing page and all sections may be blank with the exception of the address and the asking price of the property. The TRES may require each section of the listing to be complete and publishable. The address and the price of the property may be prepopulated into this section from the address in sellers account. The prepopulated price and the description of the property may be modified by the user at any time. Basic details that are uniform to all listings may be pre-populated by the TRES. The TRES may prepopulate listing metrics based on the address. When selecting the HOA section, seller 120 may be asked if the property is part of an HOA. If the response is “yes,” then the seller is sent to a page with questions specific to HOA amenities. If the response is “no” to the HOA question, seller 120 may be redirected to the property listing page with the section marked as complete.

As shown in FIG. 5, the listing creation may begin at operation 502, where seller 120 may be prompted to confirm the property information. The property information may be imported from seller's account. After seller 120 has confirmed the property information, application 106 at operation 506, may prompt seller 120 to add property description. Application 106 may further, at operation 508, prompt seller 120 to add features of the property, at operation 510 prompt seller 120 to add feature description, and at operation 512 prompt seller 120 to provide all inclusions and or exclusions.

At operation 514, application 106 may prompt seller 120 if a survey for the property is available. If seller 120 has had a survey done for the property, application 106, at operation 516 may prompt seller 120 to upload the survey results. Similarly, application 106, at operation 518, may prompt seller 120 if there is a pre-inspection report of the property available. If seller 120 has a pre-inspection report for the property, application 106, at operation 520 may prompt seller 120 to upload the pre-inspection report. In addition, at operation 522, application 106 may prompt seller 120 whether he/she wants a potential buyer to be verified. At operation 524, application 106 may prompt seller 120 with a picture tutorial and at operation 528 to add pictures of the property.

Finally, at operation 530 application 106 may prompt seller 120 to agree to the seller's listing agreement. For example, upon completion of all elements of the listing, seller 120 may be prompted to a contract screen where he/she may view fees associated with using the TRES and a link to the seller's listing agreement. Seller 120 may accept and sign the seller's listing agreement digitally. Seller 120 may use a third party electronic signature company to complete this step.

Once seller 120 has signed the seller's agreement, application 106, at operation 532, may display the completed listing information to seller 120. When seller 120 has reviewed the completed listing information, application 106, at operation 534, may send the listing information to the TRES verification system. Once the listing information has been verified by the TRES, application 106, at operation 536, may allow seller 120 to share the listing. For example, application 106, at operation 538, may allow seller 120 to share the listing on email or social media. In addition, when the listing information has been verified by the TRES, at operation 540, the TRES may display the verified listing on the web page and a seller specific screen.

In one embodiment, a photo gallery of the property listing section may leverage a custom library and image capture system. Photos may be loaded from the existing photos on the user's library or may be captured via camera on the fly. Photos may be cropped to fit the format of the ratio of the photo gallery pages. After photos are loaded and cropped, seller 120 may be directed to add a photo caption, and predetermined description tags that describe what is in the image. These photo tags may be shown in conjunction with the photo on the gallery pages and additionally populate the feature descriptions on the detailed listing page. Seller 120 may also be prompted to include any information special Features that aren't listed in the photo tags.

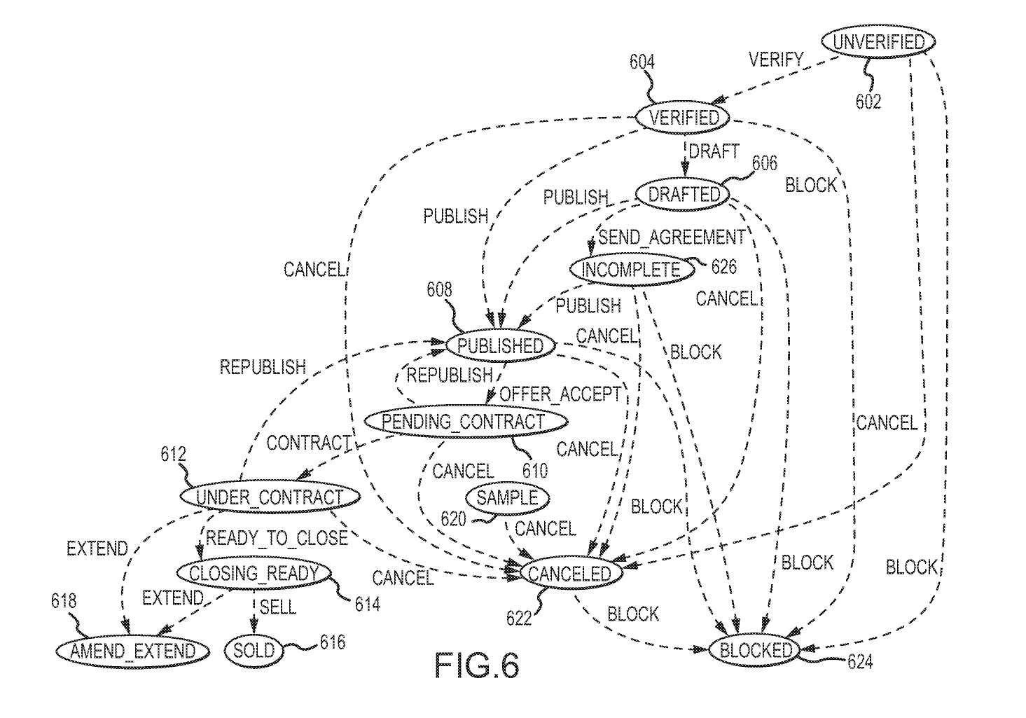

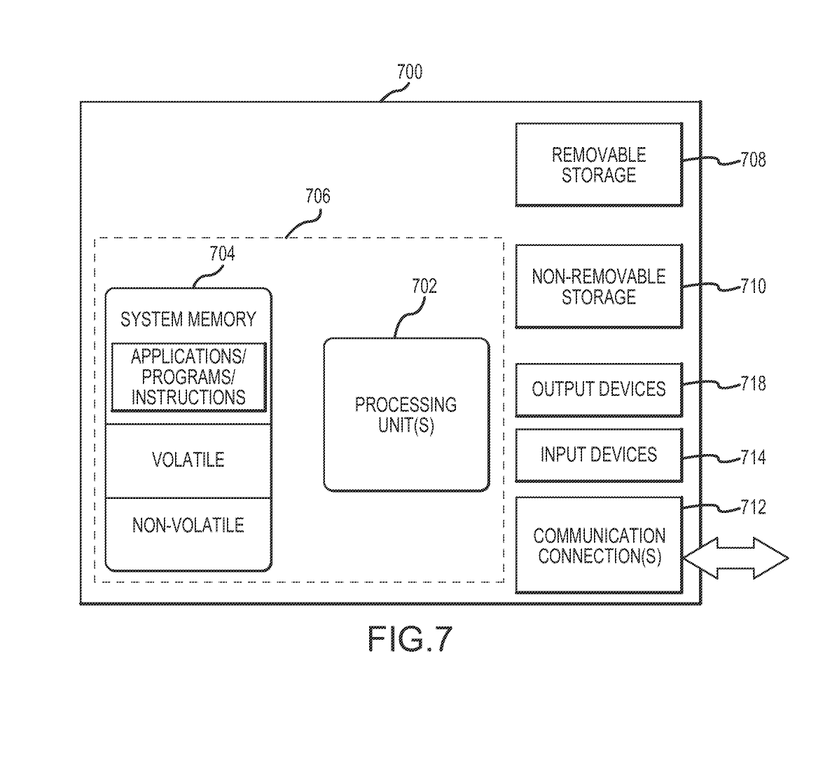

FIG. 6 illustrates one example of a state diagram associated with transaction of real estate as described herein. The state diagram shown in FIG. 7 may be realized by creating a state machine on server 110. For example, a list of states may be created by an administrator of the TRES system. The list of states may include: unverified (602), verified (604), drafted (606), incomplete (626), published (608) (also referred to as for sale), pending-contract (610), under-contract (612), closing-ready (614), sold (616), amend-extend (618), sample (620), canceled (622), and blocked (624).

Each of the states may have one or more defined properties related to real-estate transaction. For example, a property in ‘unverified’ state may be a property on the list for which the address verification is not completed. Hence buyer 122 showing interest in the ‘unverified’ property may be notified of the same. Similarly, a property under ‘verified’ state may be property for which all the descriptions available on the web page have been verified. Moreover, ‘incomplete’ state may indicate that seller 120 has not yet assented to the seller's agreement.

A property with drafted (606) state may be property where the listing specifications has been provided and verified and the property is ready to be published. A property with published (608) state is property which is published on the web page and is available for viewing. A property with pending-contract (610) is a property where an offer from buyer 122 has been accepted by seller 120, but negotiations are not completed yet. A property with under-contract (612) state may represent a property where buyer 122 and seller 120 have signed a contract and are in post negotiation phase. A property with the closing-ready (614) state may represent a property where buyer 122 and seller 120 has signed a contract and agreed to inspection reports, and only payments are pending.

In addition, the TRES may further define state transitions for each state. As depicted in FIG. 7, the state transitions may include ‘verify’, ‘draft’, ‘publish’, ‘send agreement’, ‘cancel’, ‘block’, ‘send’, etc. The state transitions may include buyer's actions, seller's actions, third party actions, etc. The state transitions may determine a valid state transition from a current state to a next state of the property transaction. For example, the TRES may define ‘verify’ to be a valid state transition from the ‘unverified’ state to the ‘verified’ state. Web application 114 may keep track of both buyer's and seller's actions, and update the state of the property transaction based on those actions during the negotiations. Web application 114 may update the web page for the property listings to reflect the latest state of the property.

In one embodiment, the TRES may publish the state of the property transaction on listing the web page so that a potential buyer is aware with status of the negotiation. In addition, multiple buyers negotiating with a single seller may automatically get notification from the TRES of the updates on negotiations. For example, when buyer 122 initiates ‘make offer’ for a property in ‘pending contract’ state, he may receive a notification that an initial contract for the property has been agreed between seller 120 and another buyer. Buyer 122 may be provided with an option to put the property on a watch list to receive notification for change in state during the contract negotiation.

In one embodiment, the TRESS may provide a buying section for buyer 122. The buying section may specifically be created for users (buyers and sellers) who are actively looking to purchase a property. The buying section may provide a list view of “favorites” or “watched properties.” The properties shown in this section may be chosen by clicking on a ‘star icon’ on a browsing listing screen. This section may look the same as the regular list view in the browsing section with the addition of the star icon being activated. A user may not need to be signed in or have an account to favorite or watch properties.

A second buying section may provide a list of requested (future, past, present) showings. When a user clicks on any one of the showings they may be directed to a third screen showing the details of the house with the scheduled showing time. The third screen may be a page identical to the detail view page with the addition of the requested showing information shown on the page. The fourth screen may provide a list of all negotiations by a buyer. Current and past negotiations may be shown on the fourth screen. If a buyer selects any negotiation thread they may be navigated to a negotiation specific board where they can see the current status of the negotiation. A fifth screen may a list of any and all the contracts that a buyer has signed. If a contract is selected, the user may be shown a digital copy of the executed contract. A sixth screen may provide an alert that warns the buyer that they have hit a predetermined maximum offer limit. The offer limit can be as low as one or as high as 100.

FIG. 7 illustrates one example of a suitable operating environment 700 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 700 typically may include at least one processing unit 702 and memory 704. Depending on the exact configuration and type of computing device, memory 704 (storing, among other things, venue-based applications module(s), e.g., venue check-in applications, venue search applications, geocoding/reverse geocoding applications, APIs, programs etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 7 by dashed line 706. Further, environment 700 may also include storage devices (removable, 708, and/or non-removable, 710) including, but not limited to, magnetic or optical disks or tape. Similarly, environment 700 may also have input device(s) 714 such as keyboard, mouse, pen, voice input, etc. and/or output device(s) 716 such as a display, speakers, printer, etc. Also included in the environment may be one or more communication connections, 712, such as LAN, WAN, point to point, etc.

Operating environment 700 may include at least some form of computer readable media. The computer readable media may be any available media that can be accessed by processing unit 702 or other devices comprising the operating environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The operating environment 700 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

As stated above, a number of program modules and data files may be stored in the system memory 404. While executing on the processing unit 402, program modules 408 (e.g., applications, Input/Output (I/O) management, and other utilities) may perform processes including, but not limited to, one or more of the stages of the operational methods described herein such as method 200 and method 300 illustrated in FIG. 2 and FIG. 3, for example.

Furthermore, examples may be practiced in an electrical circuit comprising discrete electronic elements, packaged or integrated electronic chips containing logic gates, a circuit utilizing a microprocessor, or on a single chip containing electronic elements or microprocessors. For example, examples may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 400 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples may be practiced within a general purpose computer or in any other circuits or systems.

This disclosure described some aspects of the present technology with reference to the accompanying drawings, in which only some of the possible embodiments were shown. Other aspects may, however, be embodied in many different forms and should not be construed as limited to the embodiments set forth herein. Rather, these aspects were provided so that this disclosure was thorough and complete and fully conveyed the scope of the possible embodiments to those skilled in the art.

Although specific aspects were described herein, the scope of the technology is not limited to those specific embodiments. One skilled in the art will recognize other embodiments or improvements that are within the scope and spirit of the present technology. For example, although described in the context of buying and selling real estate property TRES may be equally adapted to any other products or personal property that require more attention, such as a physical inspection, than a normal consumer item. Such products include livestock, agricultural products, chemical feedstocks, vehicles, heavy equipment, aircraft, or capital equipment. Therefore, the specific structure, acts, or media are disclosed only as illustrative embodiments. The scope of the technology is defined by the following claims and any equivalents therein.

What is claimed is:

1. A computer implemented method comprising:
receiving, at a processing device, information from a first user device, wherein the information comprises data that corresponds to an offer to sell a real estate property;
extracting, from the received data, a set of terms comprising an offer price, a payment method for the offer price, and a series of milestones each comprising an associated closing time;
creating, based on the extracted set of terms, a packaged offer for the real estate property, the packaged offer comprising attributes of the product stored on a memory device accessible to the processing device and the extracted set of terms; and
transmitting the packaged offer to a second user device.

2. The method of claim 1, further comprising:
receiving, from the second user device, an assent to the packaged offer;
generating a first contract for a sale of the real estate property; and
sending the first contract to the first user device and the second user device for assent.

3. The method of claim 2, further comprising:
receiving an inspection report for the real estate property; and
sending the inspection report to the first user device.

4. The method of claim 3, further comprising:
receiving data from the first user device corresponding to the inspection report;
determining a price deduction from the offer price for the real estate property based on the data corresponding to the second inspection report;
generating an addendum to the first contract based on the inspection report; and
sending a second contract to the first user device and the second user device, the second contract comprising the first contract and the addendum.

5. The method of claim 1, further comprising receiving the assent to the second contract from the first user device and the second user device.

6. The method of claim 1, further comprising:
receiving, from the second user device in response the packaged offer, a counter offer for the real estate property;
creating a packaged counter offer for the real estate property; and
transmitting the packaged counter offer to the first user device

7. The method of claim 1, wherein receiving the information from the first user device comprising receiving the information from an application on the first user device.

8. A system for managing listing of a real estate property, the system comprising
a processing unit; and
a memory comprising instructions which, when executed, configure the processing unit to:
receive, from a first user device, a request to create a listing of a real estate property from a first user;
receive, from the first user, a first set of information comprising user identifying information for a first user and product identifying information for the real estate property;
publish a listing of the product with a coming soon state, wherein publishing with the coming soon state prevents any transaction on the real estate property,
verify the first user based on the user identifying information,
update, upon verification of the first user, the state of the listing of the real estate property from the coming soon state to an unverified state, wherein when published in the unverified state allows a second user to schedule an inspection for the real estate property.

9. The system of claim 8, further comprising when published in the unverified state prevents the second user from signing a contract for acquiring the real estate property.

10. The system of claim 9, wherein the instructions which when executed further configure the processing unit to:
process the real estate property identifying information to verify an address associated with the real estate property; and
update, upon verification of the address, the state of the real estate property from the unverified state to a for-sale state, wherein when published in the for-sale state allows the second user to sign the contract for acquiring the real estate property.

11. The system of claim 9, wherein the first user device is at least one of the following: a mobile device and a personal computing device.

12. The system of claim 10, wherein instructions which when executed further configure the processing unit to:
receive, from a second user device, a request to show the real estate property,
send, to the first user device and the second user device, a schedule for showing the real estate property.

13. The system of claim 10, wherein instructions which when executed further configure the processing unit to:
receive from the second user device data that corresponds to an offer for the real estate property;
extract, from the received data, a set of terms comprising an offer price, a payment method for the offer price, and a series of milestones each comprising an associated closing time;
create, based on the extracted set of terms, a packaged offer for the real estate property, the packaged offer comprising attributes of the real estate property and the extracted set of terms; and
transmit the packaged offer to the first user device.

14. The system of claim 13, wherein instructions which when executed further configure the processing unit to:
receive, from the first user device, an assent to the packaged offer;
generate a first contract for the real estate property; and
send, to the first user device and the second user device, the first contract for assent from the first user and a second user associated with the second use device.

15. The system of claim 14, wherein instructions which when executed further configure the processing unit to:
receive, from the first user device and the second user device, the assent to the first contract; and
update the state of the real estate property from the for-sale state to a under-contract state.

16. The system of claim 15, wherein instructions which when executed further configure the processing unit to:
receive an inspection report for the real estate property from a third party; and
send the inspection report to second user device for assent from the second user.

17. The system of claim 16, wherein instructions which when executed further configure the processing unit to:
receive, from the second user device, the assent to the inspection report; and
send the inspection report to the first user for assent from the first user.

18. The system of claim 17, wherein instructions which when executed further configure the processing unit to:
receive, from the first user device, the assent to the inspection report; and
create an addendum to the first contract, wherein the addendum is created based on the inspection report;
send, to the first user device and the second user device, a second contract comprising the first contract and the addendum.

19. The system of claim 18, wherein instructions which when executed further configure the processing unit to:
receive, from the first user device and the second user device, the assent to the second contract; and
update the status of the real estate property from the for-sale state to a under-contract state.

20. The system of claim 13, wherein instructions which when executed further configure the processing unit to:
receive, from the first user device, a counter offer for the real estate property;
create a packaged counter offer for the real estate property based on the counter offer price; and
transmit the packaged counter offer to the second user device.

21. A computer implemented method comprising:
determining, by a server, a plurality of states for sale of a real estate property, each of the plurality of states being defined by at least one actionable attribute;
determining, by the server, a list of valid state transitions for the plurality of states, the list of valid state transitions comprising a set of actions for the valid transitions;
storing the plurality of states, the at least one actionable attribute associated with each of the plurality of states, and the list of valid state transitions in a database;
receiving an indication of interaction for the sale of the real estate property from a first user device;
receiving, from a first user device, a first action associated with the sale of the real estate property;
determining whether the first action matches with a valid state transition from a current state to another state; and
updating, in response to determining that the first action matches with the valid state transition, the state of the real estate property from the current state to the another state.

22. The method of claim 21, wherein the plurality of states comprises at least one of the following: an unverified state, a for-sale state, a drafted state, a published state, a pending-contract state, an under-contract state, a closing-ready state, a sold state, an amend-extend state, a canceled state, and a blocked state.

23. The method of claim 21, wherein the at least one actionable attribute for the real estate property in unverified state comprises an address verification is not completed.

24. The method of claim 21, wherein the at least one actionable item for the real estate property under for-sale state comprises descriptions available for the real estate property have been verified.

25. A computer implemented method comprising:
receiving, from a first user device, a request to view a listing of real estate properties available in a predetermined area;
sending, to the first user device, the listing of the real estate properties available in the predetermined area, the listing comprising a current state and filtered information for each the real estate properties, a state defining at least one actionable attribute for a real estate property;
receiving, from the first user device, a selection of at least one real estate property from the listing of real estate properties;
sending, to the first user device, a detailed information for the selected at least one real estate property;
receiving, from the first user device, an indication of interest in acquiring a real estate property from the selected at least one real estate property;
sending, based on the current state of the real estate property, a response to the indication of the interest.

26. The method of claim 25, wherein sending the response comprises sending a notification indicating an unverified state of the real estate property, wherein the unverified state only allows a second user to schedule an inspection for the real estate property and prevents from signing a contract.

27. The method of claim 25, wherein sending the response comprises sending a notification indicating an under contract state of the real estate property, wherein the unverified state indicating a seller of the real estate property is negotiating with at least one buyer.

28. The method of claim 25, further comprising:
receiving, from a first user device, data that corresponds to an offer for the real estate property;
extracting, from the received data, a set of terms comprising an offer price, a payment method for the offer price, and a series of milestones each comprising an associated closing time;
creating, based on the extracted set of terms, a packaged offer for the real estate property, the packaged offer comprising attributes of the real estate property stored on a memory device accessible to the processing device and the extracted set of terms; and
transmitting the packaged offer to a second user device.

29. The method of claim 28, further comprising:
receiving an assent to the packaged offer;
generating a first contract for a sale of the real estate property; and
updating the current state of the product to a pending contract state.

30. The method of claim 28, further comprising:
monitoring the closing time associated with each of the milestones; and
revoking a power of acceptance for the packaged offer at an expiry of the closing time.
